(19) United States
(12) Patent Application Publication
(10) Pub. No.: US 2013/0097056 A1
(43) Pub. Date: Apr. 18, 2013

(54) METHODS AND SYSTEMS FOR RECOMMENDING SERVICES BASED ON AN ELECTRONIC SOCIAL MEDIA TRUST MODEL

(71) Applicants: Tong Sun, Penfield, NY (US); Lei Li, Miami, FL (US); Hua Liu, Fairport, NY (US)

(72) Inventors: Tong Sun, Penfield, NY (US); Lei Li, Miami, FL (US); Hua Liu, Fairport, NY (US)

(73) Assignee: XEROX CORPORATION, Norwalk, CT (US)

(21) Appl. No.: 13/272,811

(22) Filed: Oct. 13, 2011

(51) Int. Cl. G06F 15/16; G06Q 30/06

(52) U.S. Cl. 705/26.35; 709/204

(57) ABSTRACT

Methods and systems for recommending a service based on an electronic social media trust model. A user trust network and a service trust network can be constructed and the two separate trust networks can be combined to form a combined trust network. The combined trust network includes an explicit trust and an implicit trust in order to improve the recommendation coverage and consider a latent service rating without suffering noisy data. A trust-oriented random walk model can be conducted on a user node with respect to the combined trust network based on a user search intent and navigation behavior in order to select and recommend a service candidate. A service rating can then be predicted by considering the user ratings with respect to a target service, a propagated trust and an inferred service rating.

### TECHNICAL FIELD

Embodiments are generally related to social network marketing. Embodiments are also related to service recommendation methods and systems. Embodiments are additionally related to trust management techniques. Embodiments are further related to an electronic social media trust model.

### BACKGROUND OF THE INVENTION

Social media generally involves a large number of users who interact socially with one another in an electronic social network environment. In such a paradigm, users can freely express and share opinions with other users via an electronic social networking application. Social media encompasses online media such as, for example, collaborative projects (e.g. Wikipedia), blogs and microblogs (e.g. Twitter), content communities (e.g. YouTube), social networking sites (e.g. Facebook), virtual game worlds (e.g. World of Warcraft), and virtual social worlds (e.g. Second Life).

In the context of such electronic social media, a service marketplace portal can be utilized to position a strategic broker role in a business service. Such an envisioned service marketplace portal can provide an easy-to-use interface that allows a business service buyer to navigate, find, and compose a service based on, for example, the requirement of a service provider to upload, register, and host the service. Such service marketplace portal can also include a collaborative social portal that permits the business user (e.g., including both buyer and seller) to reuse the existing social media accounts for seamless login and additionally, to interact with each other via an online community forum. Such a collaborative social portal can also establish various social circles (e.g. friends, collaborators, following/follower, etc.), and rate sellers and/or services based on user experiences. With the advent of online social networks and the increasing abundance of web services, it is crucial that a service marketplace portal provide an effective recommendation approach for assisting users in navigating and determining relevant services in the marketplace platform.

Several approaches have been developed to select and recommend a service. In one approach, collaborative filtering can be employed to recommend a service based on similarities between user profiles, preferences, interests, and historical experiences. Such a collaborative filtering approach suggests a service to an end-user by collecting preferences from many users (e.g., collaborating). Such an approach suffers from a cold-start problem that requires gathering and analyzing a considerable set of end-users' interactions before being able to infer implicit similarities between users and to provide recommendations.

Another approach involves the use of a trust-based recommendation to deal with the aforementioned cold start problem by introducing additional knowledge of an explicit trust network between users. The trust-based recommendation only considers the user social network with the explicit trust and item similarity relationship, and does not possess any network relationship among items. Meanwhile, as the length of the propagation-path increases on the trust network, the trust between users and a source user can become fairly weak, and the probability of utilizing the rating of a similar service instead of the rating of a target service increases as well. Such conventional user-centric explicit trust-based approaches lead to noisy and unreliable predictions, and decreased recommendation accuracy.

Based on the foregoing, it is believed that a need exists for improved methods and systems for recommending a service based on an electronic social media trust model. A need also exists for an improved approach for providing a trust-oriented random walk model for selecting and recommending a service candidate, as will be described in greater detail herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved service recommendation methods and systems.

It is another aspect of the disclosed embodiments to provide for improved methods and systems for recommending a service based on an extended online social trust model.

It is a further aspect of the disclosed embodiments to provide for an improved method and system for providing a trust-oriented random walk model for selecting and recommending a service candidate.

The aforementioned aspects and other objectives and advantages can now be achieved as described herein. Methods and systems for recommending a service based on an electronic social media trust model are disclosed herein. A user trust network and a service trust network can be constructed and the two separate trust networks combined to form a combined trust network. The combined trust network generally includes an explicit trust (e.g. trust value explicitly indicated by users) and an implicit trust (e.g. trust value inferred or propagated from users) in order to improve recommendation coverage and consider a latent service rating without suffering noisy data.

A trust-oriented random walk model can be conducted on a user node with respect to the combined trust network and based on a user search intent and navigation behavior in order to select and recommend a service candidate. A service rating can then be predicted by considering user ratings with respect to a target service, a propagated trust and an inferred service rating. Such an approach enables a deeper “walk” into the networks and identifies hidden/implicit trust relationships while calculating scores that better represent trust relationships in order to provide an accurate service recommendation.

The user trust network and the service trust network can be configured to include a number of nodes that represent the users (e.g., a service buyer or a seller) in the social network and a number of edges that connect the nodes represent a trusted relationship (e.g., friend, colleague, business contact) between the users. The user trust network can be built upon an aggregated external and internal social network with the explicit and implicit trust value that can be represented based on an internal relationship, an external relationship, and a propagated relationship. A user relationship can be imported from an external social media (e.g. Facebook, Twitter, and LinkedIn) and an explicit Boolean trust value can be derived based on the relationship defined in a social media contact. The implicit trust value can be computed based on a user interaction between the users (e.g., comments, messages, notes, wall posts, etc.) if the explicit relationship does not exist.

The internal relationship can be established and captured from a service marketplace portal and the explicit trust rating given by a user (or buyer) to a second user based on a quality of service provided by the second user (or seller) can be computed. The implicit trust value based on the user interaction in the marketplace portal can be determined if the explicit relationship does not exist. The propagated relationship can be determined based on a buyer aggregated rating on a service provided by a seller. A mean value of the buyer aggregated rating on the service provided by the seller can be calculated to determine an implicit trust value. An edge weight can then be computed to denote the trust value of the users and the explicit and implicit propagated trust value.

The service trust network can be computed with a set of vertices, each of which denotes the service and a set of edges between the vertices represents a dependence type transaction between the services. The set of vertices can be separated into several semantic service categories (or service ontology) identified by an agglomerative hierarchical clustering based on a service pair-wise semantic similarity. A trust value from a service usage log can be obtained and the edge weight can be computed to represent the trust value between the services.

The user trust network and the service trust network can be correlated and combined utilizing the user service rating and a service ownership in order to thereafter generate the propagated trust and the inferred service rating. A direct trustful relationship between the users who are not directly connected in the social network can be added in order to enrich the user trust network by utilizing the propagated relationship. The inferred service rating can be determined based on a trustful value between the users even if the user does not previously rate the service provided by another user but possesses a direct connection in the social network.

The random walk can be stopped if the user on a step possesses a rating on a target service and a service rating value can be returned. The random walk can be terminated if the user does not have a rating and the service similar to the target service rated by the user can be selected and returned. Otherwise, the random walk can be terminated and the random walk can be performed with respect to another user who is a direct trusted neighbor. The service trust network can be incorporated into a rating calculation in order to provide reliable ratings for the target service with less data noises. The random walk can be performed once or a number of times for each target service within a navigation category based on whether the user is navigating in the service marketplace category or search for the interested service. The ratings returned by the random walk can be aggregated in order to obtain a predicted rating if the random walk is performed several times.

### BRIEF DESCRIPTION OF THE DRAWINGS

The accompanying figures, in which like reference numerals refer to identical or functionally-similar elements throughout the separate views and which are incorporated in and form a part of the specification, further illustrate embodiments and, together with the detailed description of the invention, serve to explain the principles of the disclosed embodiments.

FIG. 1 illustrates a schematic view of a computer system, in accordance with the disclosed embodiments;

FIG. 2 illustrates a schematic view of a software system including a trust-oriented service recommendation module, an operating system, and a user interface, in accordance with the disclosed embodiments;

FIG. 3 illustrates a block diagram of a trust-oriented service recommendation system, in accordance with the disclosed embodiments;

FIG. 4 illustrates a high level flow chart of operations illustrating logical operational steps of a method for recommending a service based on an electronic social media trust model, in accordance with the disclosed embodiments;

FIG. 5 illustrates a schematic diagram of a social network graph depicting a user trust network, in accordance with the disclosed embodiments;

FIG. 6 illustrates a schematic diagram of a social network graph depicting a service trust network, in accordance with the disclosed embodiments;

FIG. 7 illustrates a schematic diagram of a social network graph depicting a combined trust network, in accordance with the disclosed embodiments;

FIG. 8 illustrates a schematic diagram of a social network graph depicting a propagated trust network, in accordance with the disclosed embodiments;

FIG. 9 illustrates a schematic diagram of a social network graph depicting an inferred service rating, in accordance with the disclosed embodiments; and

FIG. 10 illustrates an algorithm for conducting a random walk on the user nodes in the combined trust network, in accordance with the disclosed embodiments.

### DETAILED DESCRIPTION

The embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one skilled in the art, the present invention can be embodied as a method, data processing system, or computer program product. Accordingly, the present invention may take the form of an entire hardware embodiment, an entire software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.). The computer program code, however, for carrying out operations of the present invention may also be written in conventional procedural programming languages such as the “C” programming language or in a visually oriented programming environment such as, for example, VisualBasic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet using an Internet Service Provider).

The invention is described in part below with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

Although not required, the disclosed embodiments will be described in the general context of computer-executable instructions, such as program modules, being executed by a single computer. In most instances, a “module” constitutes a software application. Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application such as a computer program designed to assist in the performance of a specific task such as word processing, accounting, inventory management, etc.

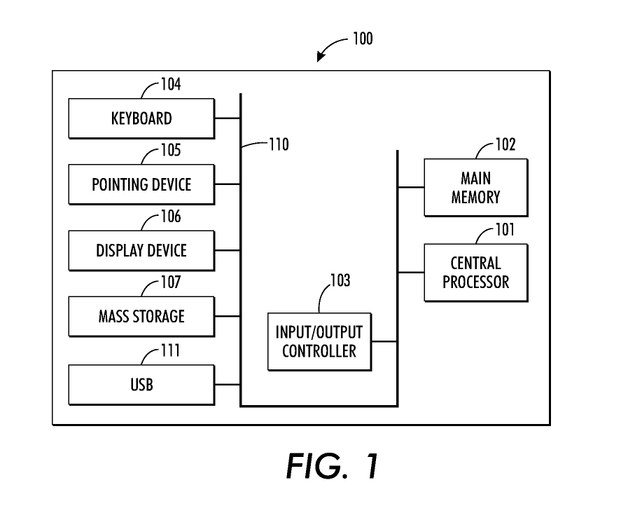

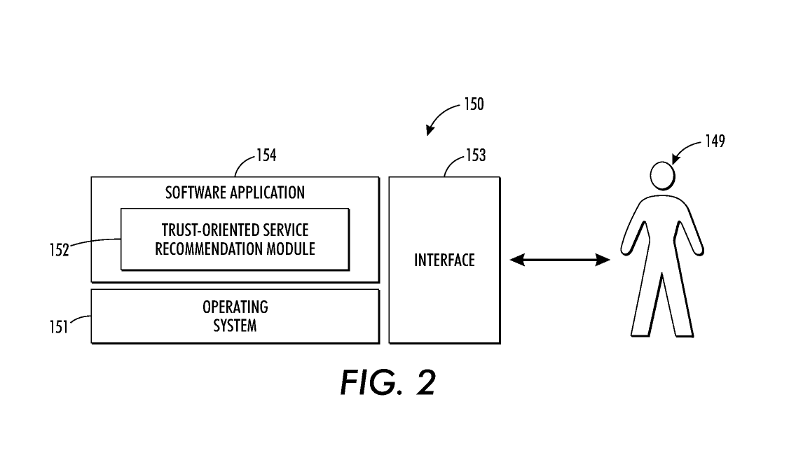

FIGS. 1-2 are provided as exemplary diagrams of data-processing environments in which embodiments of the present invention may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, the disclosed embodiments may be implemented in the context of a data-processing system 100 that includes, for example, a central processor 101, a main memory 102, an input/output controller 103, a keyboard 104, an input device 105 (e.g., a pointing device such as a mouse, track ball, and pen device, etc.), a display device 106, a mass storage 107 (e.g., a hard disk), and also, for example, a USB (Universal Serial Bus) peripheral connection 111. As illustrated, the various components of data-processing system 100 can communicate electronically through a system bus 110 or similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 154, stored in main memory 102 and on mass storage 107, generally includes a kernel or operating system 151 and a shell or interface 153. One or more application programs, such as software application 152, may be “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating system module 152 and/or software application 154.

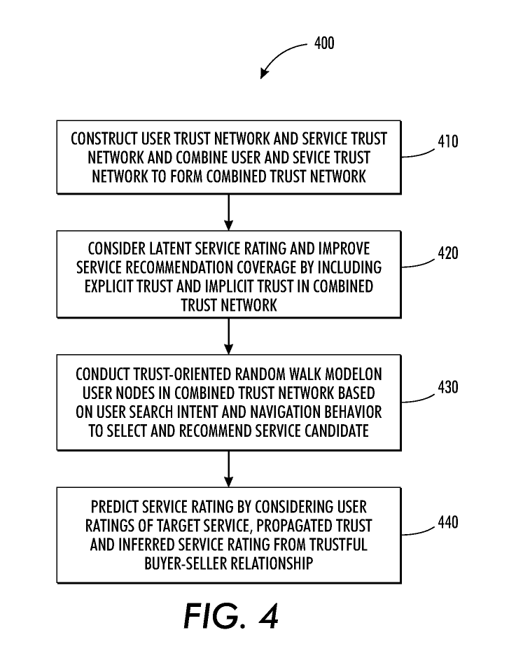

The interface 153 is preferably a GUI (Graphical User Interface) that serves to display results, whereupon a user may supply additional inputs or terminate a session. In one embodiment, operating system 151 and interface 153 can be implemented in the context of a “Windows” system. It can be appreciated, of course, that other types of systems are possible. For example, rather than a traditional “Windows” system, other operation systems such as, for example, Linux may also be employed with respect to operating system 151 and interface 153. The software application 154 can include a trust-oriented service recommendation module 152 for recommending a service based on an electronic social media trust model. Software application 154, on the other hand, can include instructions such as the various operations described herein with respect to the various components and modules described herein such as, for example, the method 400 depicted in FIG. 4.

FIGS. 1-2 are thus intended as examples and not as architectural limitations of the disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms including Macintosh, UNIX, LINUX, and the like.

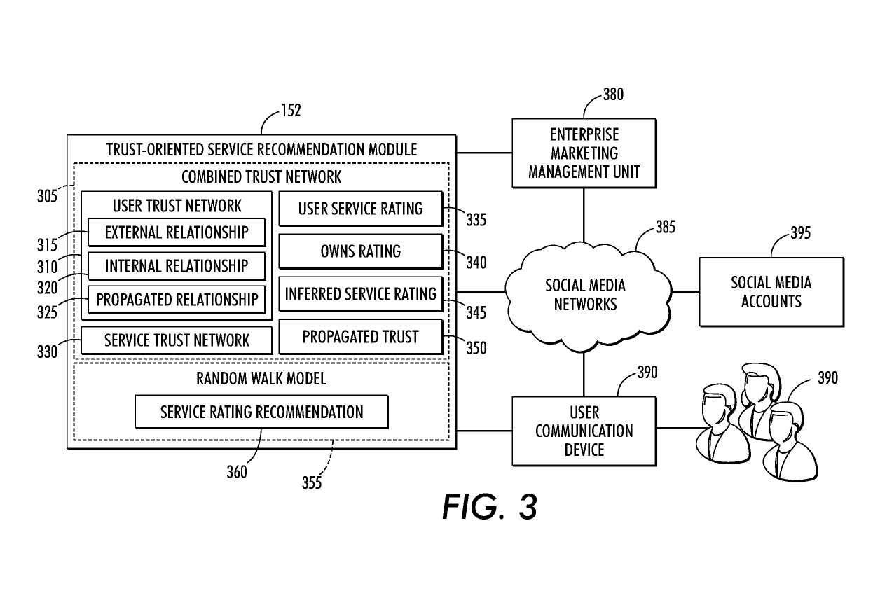

FIG. 3 illustrates a block diagram of a trust-oriented service recommendation system 300, in accordance with the disclosed embodiments. Note that in FIGS. 1-10, identical parts or elements are generally indicated by identical reference numerals. The social media networks 385 can be configured to include the trust-oriented service recommendation module 152 for recommending a service based on an electronic social media trust model. The social media networks 385 include social media, for example, networks, websites, or computer enabled systems. For example, a social media network may be, for example, MySpace, Facebook, Twitter, Linked-In, Spoke, etc., or other similar computer enabled systems or websites. A user communication device 390 can communicate with the social media networks 385. Note that the user communication device 390 can be, for example, a mobile communication device, a data-processing system, or a web-enabled device, depending upon design considerations.

In general, service recommendation is the process to automatically identify the usefulness of (web) service categories or instances in a given situation, and then proactively discover and recommend services to an end-user. The term trust as utilized herein is intended to mean any positive relationship conductive to trust in the real world, for example, friendship, kinship, and business transactions among users and services. Similarly, a user liking a social object (e.g. post, photo, video) or service is also appropriate. Meanwhile, the frequency and time spent on the interactions with other users and services also imply the trust.

The trust-oriented service recommendation system 300 includes a service marketplace portal 380 to provide a number of business management functions and services to the users 390. The term user as utilized herein is intended to mean a seller, the provider of the goods or services, or a buyer, the purchaser of the goods or services. The trust-oriented service recommendation module 152 constructs a user trust network 310 and a service trust network 330, and the two separate trust networks are combined to form a combined trust network 305. As will be described in greater detail below, the user trust network 310 and the service trust network 330 may be represented by a graph that comprises a number of nodes and a number of edges. The nodes represent individuals in the social network 385 of a user, and the edges represent a trusted relationship between individuals represented by the nodes of the graph. The combined trust network 305 includes an explicit trust and an implicit trust in order to improve the recommendation coverage and consider a latent service rating without suffering noisy data. The explicit trust includes the trust value explicitly indicated by the users 390 and the implicit trust includes trust value inferred or propagated from users' social relationships, dynamic user interactions, and/or historical user-experiences with services.

A trust-oriented random walk model 355 can be conducted on the user nodes with respect to the combined trust network 305 based on the user search intent and navigation behavior in order to select and recommend a service candidate. In general, a random walk is a mathematical formalization of a trajectory that consists of taking successive random steps. A service rating 360 can then be predicted by considering the users' rating 335 of the target service, an ownership rating 340, a propagated trust 350, and an inferred service rating 345 from a trustful buyer-seller relationship. The system 300 enables a deeper walk into the networks 385 and identifies hidden/implicit trust relationships and calculates the scores that better represent the trust relationships in order to provide an accurate service recommendation.

FIG. 4 illustrates a high level flow chart of operations illustrating logical operational steps of a method 400 for recommending a service based on an electronic social media trust model, in accordance with the disclosed embodiments. Note that the method 400 can be implemented in the context of a computer-useable medium that contains a program product including, for example, a module or group of modules. Initially, the user trust network 310 and the service trust network 330 can be constructed and the two separate trust networks 310 and 330 can be combined to form a combined trust network 305, as shown at block 410.

The combined trust network 305 includes an explicit trust (e.g. trust value explicitly indicated by users) and an implicit trust (e.g. trust value inferred or propagated from users) in order to improve the recommendation coverage and consider a latent service rating without suffering noisy data, as indicated at block 420. The service recommender system 300 includes a separate trust network among users and services respectively. The service recommender system 300 includes a set of users (or customers) C={c₁, c₂, . . . , c_{N}} and a set of services S={s₁, s₂, . . . , s_{M}}. Each user c rates a set of services RS_{c}={s_{c1}, . . . , s_{ck}}. The rating of user c on service s is denoted by r_{c,s}, which can be any real number normalized between [0,1]. Note that the rating 0 represents “the least liked” and 1 represents “the most liked”. The user's rating can be mapped by determining how much the user “trusts” the service.

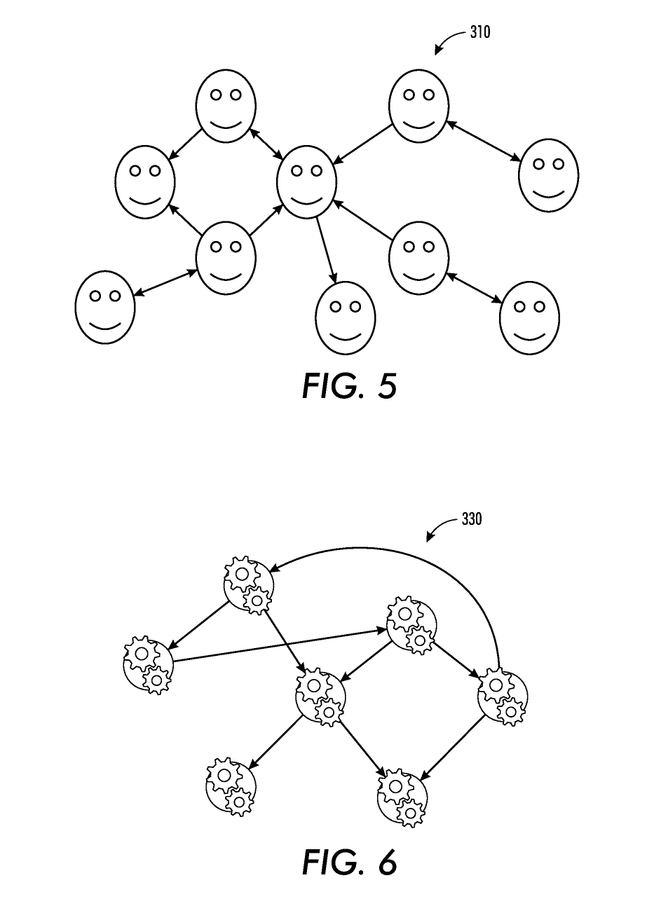

FIG. 5 illustrates a schematic diagram of a social network graph depicting a user trust network 310, in accordance with the disclosed embodiments. As shown in FIG. 5, the user trust network 310 and the service trust network 330 can be configured to include a number of nodes that represent the users (e.g., a service buyer or a seller) in the social network and a number of edges that connect the nodes represent a trusted relationship (e.g., friend, colleague, business contact) between the users. The social network graph can represent a collection of information with respect to the users and relationships there between. Note that the social network graph can handle any data-structure type forms (e.g., table, relational databases, XML based databases, and the like), without departing from the scope and spirit of the disclosed embodiments. The service marketplace portal provides all users an option to use the existing social media accounts 395 to login. Hence, the social community in the marketplace platform is semi-open and is a hybrid of internal and external social relations. Note that each user 390 of the service marketplace portal can be a service buyer or seller or both.

Formally, let C=(V^{C},E^{C}) denotes the user trust network 310, where V^{C} is a set of vertices, each of which denotes a user (buyer or seller or both), and E^{C}={(u,v)|u,vεV^{C}} is a set of edges between vertices. Note that the user trust network 310 can be built upon an aggregated external and internal social network. In order to quantify the user trust network 310, the aggregated social relations (or edges) with the explicit and implicit trust values can be represented based on an internal relationship 320, an external relationship 315, and a propagated relationship 325.

The user relationship can be imported from external online social media sites (e.g. Facebook, Twitter, LinkedIn). The explicit Boolean trust value (denoted as EEᵤᵥ^{C}) can be derived according to the u-> v or v->u relationships defined in the social media sites friend list, follower, contacts, etc. If no explicit relationship exists, an implicit trust value (denoted as EIᵤᵥ^{C}) can be computed based on the user interactions between u and v (such as comments, messages, notes, wall posts, taggings, Likes, sharing, reply, RT), as indicated in equation (1) as follows:

$${EI}_{uv}^{C} = \frac{φ ( u ↔ {v}_{i} )}{{\sum }_{j = 1}^{n} φ ( u ↔ {v}_{j} )} \qquad ( 1 )$$

wherein ø(u [symbol] vᵢ) represents the number of interactions between users u and vᵢ on external social media sites. The internal relationship 320 can be established and captured in the service marketplace portal. The explicit trust rating (denoted as IEᵤᵥ^{C}) is given by a user (or buyer u) to another based on the quality of services provided by the latter (or seller v) and can be written as shown in equation (2):

$${IE}_{uv}^{C} = \frac{{\sum }_{i = 1}^{M} {c}_{ui}}{M} \qquad ( 2 )$$

wherein cui represents the i-th rating provided by user u to user v. Similarly, if no explicit relationship exists, an implicit trust value (denoted as IIᵤᵥ^{C}) can be computed based on user interactions between users u and v in the marketplace portal's community forum, as illustrated below in equation (3):

$${II}_{uv}^{C} = \frac{φ ( u ↔ {v}_{j} )}{{\sum }_{j = 1}^{n} φ ( u ↔ {v}_{j} )} \qquad ( 3 )$$

wherein ø(u [symbol] vⱼ) represents the number of interactions between users u and vⱼ on internal marketplace community forum. The propagated buyer-seller relationship 325 can be computed based on the buyer's aggregated ratings on services provided by a certain seller. The implicit trust value (denoted as pᵤᵥ^{C}) between a buyer u and a seller v can be computed as the mean value of buyer's aggregated ratings on all services provided by seller v, as indicated in equation (4) as follows:

$${p}_{uv}^{C} = \frac{{\sum }_{i = 1}^{K} {s}_{ui}}{K} \qquad ( 4 )$$

wherein sᵤᵢ represents ratings given by the buyer u to service sᵢ and seller v provides or owns services {s₁, s₂, . . . , s_{K}}. Therefore, the edge weight tᵤᵥ^{C} denotes the trust value of two corresponding users u and v and can be written as shown in equation (5):

tᵤᵥ^{C}=α·rᵤᵥ^{C}+β·mᵤᵥ^{C}+γ·pᵤᵥ^{C} (5)

wherein rᵤᵥ^{C} is trust value for imported external social relations, rᵤᵥ^{C}=EEᵤᵥ^{C}, if there is an explicit external relationship 315 between users u and v; otherwise rᵤᵥ^{C}=EIᵤᵥ^{C}. And mᵤᵥ^{C} represents trust value for internal social relations, mᵤᵥ^{C}=IEᵤᵥ^{C}, if there is an explicit internal relationship 320 between users u and v; otherwise mᵤᵥ^{C}=IIᵤᵥ^{C}. And pᵤᵥ^{C} is the propagated trust value through service ratings by user u to all services provided by user v. Hence, the parameters α,β, γ control the significance of each trust component and α+β+γ=1.

FIG. 6 illustrates a schematic diagram of a social network graph depicting a service trust network 330, in accordance with the disclosed embodiments. Each trust network 330 is a directed weighted graph with trust value denoted as edge weight as any number between [0,1], and not all trust relationships are reciprocal. For example, consider S=(V^{S},E^{S}) denote the service trust network 330, where V^{S} is a set of vertices, each of which denotes a service. Note that V^{S} is composed of several semantic service categories (or service ontology) identified by agglomerative hierarchical clustering based on service pair-wise semantic similarities. And E^{S} represents a set of edges (or links) between vertices, E^{S}={(u,v)|u,vεV^{S}} represents the dependence (or outsourcing)-type transactions between services u and v. An example of service dependence is an online travel reservation service that may depend on third party flight booking service, hotel reservation service, and payment processing service.

The edge weight tᵤᵥ^{S} represents the trust (or dependency) value between service u and v, wherein tᵤᵥ^{S}ε[0,1] (1 means complete trust, 0 means no trust). The trust value can be obtained from service usage logs. Consider a service u and a set of service Sᵥ={v₁, v₂, . . . , vₙ} that u relies on, the service trust value between u and VᵢεSᵥ, tᵤᵥ_{ᵢ}^{S} can be computed as illustrated below in equation (6):

$${t}_{{uv}_{i}}^{S} = \frac{φ ( u -> {v}_{i} )}{{\sum }_{j = 1}^{n} φ ( u -> {v}_{j} )} , \qquad ( 6 )$$

wherein ø(u→vᵢ) denotes the number of times of outsourcing from the service u to the service vᵢ. The service trust model can be easily extended with the satisfaction of “outsourcing” or “dependence” relationship between services u and vᵢ based on vᵢ's quality of service parameters (e.g. cost, performance, delivery schedule) as long as these information are properly captured in the service usage logs.

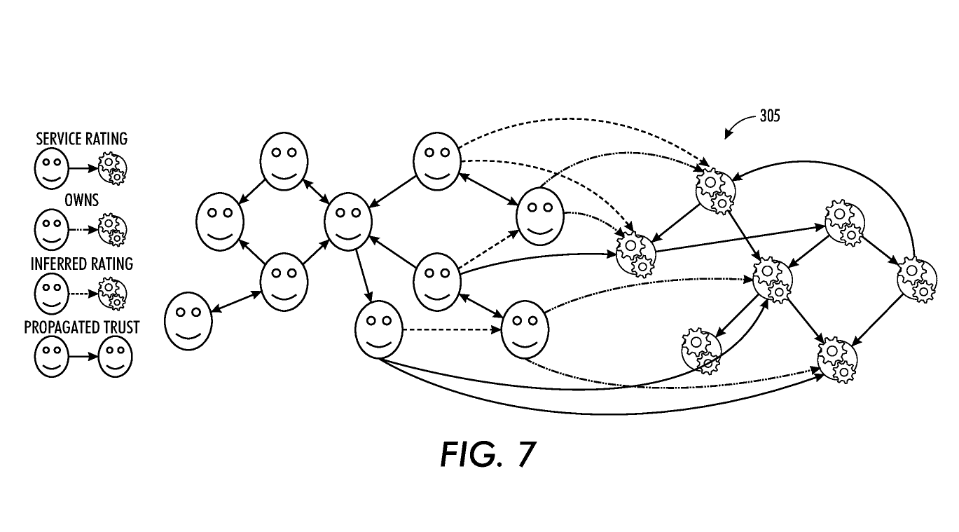

FIG. 7 illustrates a schematic diagram of a social network graph depicting a combined trust network 305, in accordance with the disclosed embodiments. As shown in FIG. 7, the two separate trust networks 310 and 330 can be correlated based on the user service rating 335 and the service ownership 340. The user (e.g., usually a buyer) can provide a service rating (e.g., value normalized between [0,1]) to indicate whether they like or trust the service based on the satisfaction of such a transaction. As a seller in the service marketplace, he/she owns or provides one or more services. The ownership implies the complete trust (e.g., with trust value=1) between the seller vertex and owned service vertices. Therefore, when combining these two trust networks, additional trust-edges can be “propagated” or “inferred”. Without introducing noisy data that can lead to low prediction precision, the trust propagation in local (i.e. one-degree separation link) combined networks is considered. Formally, let P=(V^{P},E^{P}) denote the combined trust network 305, wherein V^{P} represents a set of vertices (there are two kinds of vertices: user node and service node), and E^{P}={(u,v)|u,vεV^{P}}E^{C}∪E^{S}∪E^{I} represents a union set of edges aggregated from the user network and the service network, and inferred trust edge set E^{I} from local combined networks. E^{I} includes the propagated and inferred trust edges (or relationships).

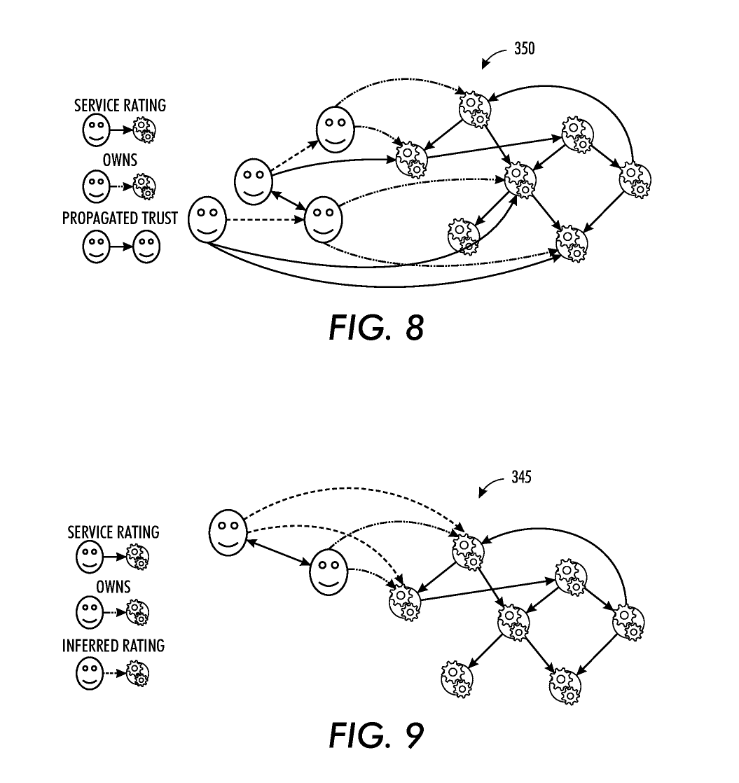

FIG. 8 illustrates a schematic diagram of a social network graph depicting a propagated trust 350, in accordance with the disclosed embodiments. The propagated buyer-seller relationships are based on the buyer's aggregated ratings on the services provided by a certain seller. This enriches the original user trust network 310 by adding direct trustful relationships among the users 390 who are not directly connected in their previous social networks. As illustrated in FIG. 8, the users u and v are not directly connected before in social networks, but user u possesses used and rated services provided by user v before. The propagate trust value pᵤᵥ^{C} can be computed as indicated in equation (7) as follows:

$${p}_{uv}^{C} = \frac{{\sum }_{i = 1}^{K} {s}_{ui}}{K} \qquad ( 7 )$$

wherein sᵤᵢ represents a rating given by the buyer u to service sᵢ and seller v provides or owns services {s₁, s₂, . . . , s_{K}}.

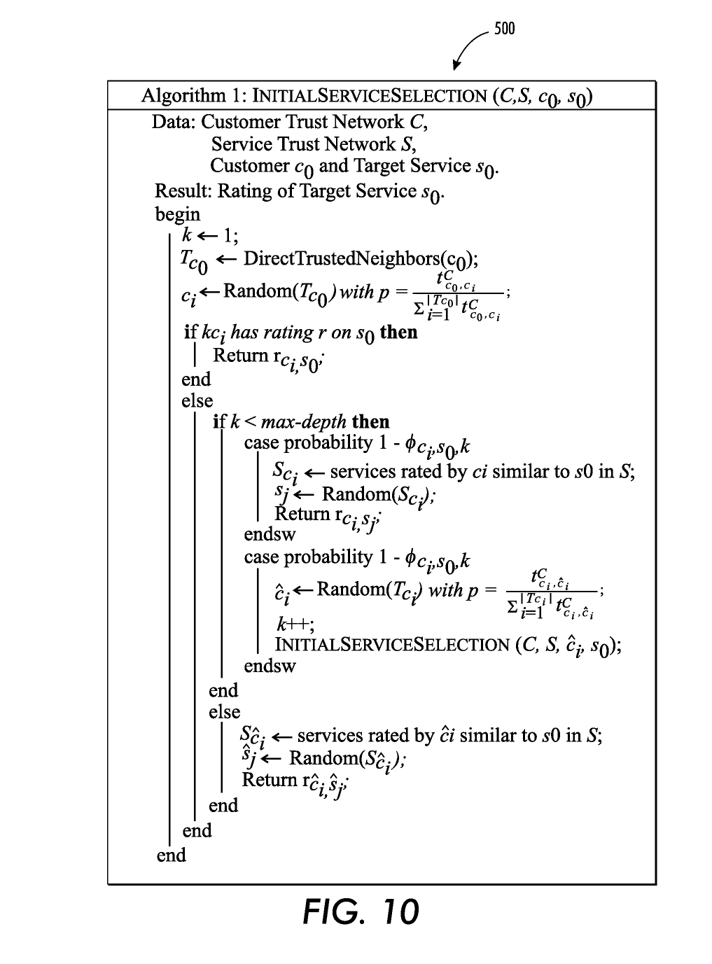

FIG. 9 illustrates a schematic diagram of a social network graph depicting an inferred service rating 345, in accordance with the disclosed embodiments. The inferred service ratings are based on trustful user relationships. As illustrated in FIG. 9, the users u and v possess a direct connection in social networks, although the user u does not previously use or rate any services provided by v. The service ratings can be inferred based on the trust value between u and v. For simplicity, the inferred service rating 345 is similar to the trust value from the buyer and the seller of the services. Several extensions can be potentially applied, such as the inferred service ratings 345 can be a weighted trust value according to the quality of service (QoS) or specialty. Note that this service rating inference is intent to tackle the rating data sparsity issue in any recommender system before the random walk model 355 on the trust network as described in FIG. 10. Without introducing noisy data that will jeopardize the prediction/recommendation precision, the ratings based on 1^{St} degree neighbors are inferred in the user trust network 310, and a minimum trust value threshold can also be heuristically set to ensure the confidence of inference.

The trust-oriented random walk model 355 can be conducted on the user nodes with respect to the combined trust network 305 based on the user's search intent and navigation behavior in order to select and recommend a service candidate, as depicted at block 430. A service rating can then be predicted by considering the users' ratings of the target service 335, the propagated trust 350, and the inferred service rating 345 from a trustful buyer-seller relationship, as illustrated at block 440.

FIG. 10 illustrates an algorithm 500 for conducting the random walk 355 on the user nodes in the combined trust network 305, in accordance with the disclosed embodiments. The procedure of the random-walk based recommendation is straight-forward. At each step of k of a random walk 355, if the user cᵢ on the step possesses the rating on target service s₀, then the random walk 355 is stopped and r_{c}_{ᵢ}_{,s}_{₀} is returned as the result. If cᵢ does not have a rating on s₀, then with probability φ_{c}_{ᵢ}_{,s}_{₀}_{, k}, the random walk 355 is terminated and the services sⱼ similar to s₀ rated by cᵢ, can be randomly selected and r_{c}_{ᵢ}_{, s}_{ⱼ} returned. Otherwise, with probability 1−φ_{c}_{ᵢ}_{,s}_{₀}_{,k}, the random walk 355 is terminated and the random walk can be performed with respect to another user ĉᵢ who is one of cᵢ's direct trusted neighbor.

Note that sⱼ is selected from the service category where the target service lies. sⱼ is similar to s₀ if these two services are at the same level of service semantics, and also the semantic similarity is higher than a threshold. In order to provide reliable ratings for the target service, the service trust network 330 is incorporated into the rating calculation such that is restricted to be the service trusted by s₀. In this way, the ratings provided by the similar services to the target services are more trustworthy with less data noises. If trust relations between s₀ and sⱼ are not available in service trust network 330, the services semantically similar to s₀ can be employed to predict the ratings.

The probability φ_{c}_{ᵢ}_{,s}_{₀}_{,k} serves to describe the chance of staying at cᵢ to select one of the service ratings at step k of the random walk 355. The probability can be related to the similarities between services rated by cᵢ and the target service. In order to avoid non-termination cases of the random walk 355, a penalty of deep steps is provided using a sigmod function of k. φ_{c}_{ᵢ}_{,s}_{₀}_{,k} can be calculated as illustrated below in equation (8):

$${φ}_{{c}_{i} , {s}_{0} , k} = {max}_{{s}_{j} ∈ {S}_{{c}_{i}}} [ sim ( {s}_{0} , {s}_{j} ) \times {t}_{{s}_{0} , {s}_{j}}^{S} ] \times \frac{1}{1 + {e}^{- \frac{k}{2}}} , \qquad ( 8 )$$

wherein sim(s₀,sⱼ) represents the similarity score between services s₀ and sⱼ, and it is controlled by tₛ_{₀}^{S}_{,s}_{ⱼ} (the trust score o s₀ to sᵢ). The random walk 355 may run once or many times for each target service s₀ within a navigation category or search results depending on whether the user is navigating in the service marketplace category or searching for interested services. Each random walk 355 returns a rating. Several random walks 355 can be performed and the aggregation of all ratings returned by different random walks 355 is considered as the predicted rating \hat{r}_{c}_{ᵢ}_{,s}_{ⱼ}. The max-depth of each random walk 355 is set as 6 according to the six-degree separation property in social networks. For recommendation, the system 300 selects the services with top ranked ratings.

The system 300 constructs the combined trust network 305 and uncovers latent service ratings and propagated trustful links among users 390 using the correlations between the user network 310 and the service network 330 via service Ownership 340 and the user service ratings 335 in order to improve the recommendation coverage. The new knowledge uncovered in the combined trust network 305 can be inferred or propagated in a localized network by considering the 1^{St} degree separation neighbors (i.e. directly connected neighbors). Meanwhile, the service ownership is a complete trust between the owner and owned services so that any propagation or inference based on such a complete trust will not further compound any “trustworthiness discount”. By adding the inferred latent service ratings 345 the probability of using the rating of the target service rather than the rating of similar services is increased, and the random walk steps may effectively decrease as well. Beyond the similarity between services, the service trust network 330 introduces the dynamic trustful links among interdependent services. Such an approach enhances the service rating prediction accuracy by considering the trust value between similar services.

Based on the foregoing, it can be appreciated that varying embodiments are disclosed herein, preferred and alternative. For example, in an embodiment, a method for recommending services can be implemented. Such a method can include, for example, the steps of configuring a user trust network and a service trust network in order to thereafter combine the user trust network and the service trust network to form a combined trust network that includes an explicit trust and an implicit trust; conducting a trust-oriented random walk model on a user node with respect to the combined trust network based on a user search intent and navigation behavior in order to select and recommend a service candidate; and predicting a service rating by considering a user rating of a target service, a propagated trust, and an Inferred service rating in order to enhance the service rating prediction accuracy and provide an accurate service recommendation.

In another embodiment, a step can be implemented for configuring the user trust network and the service trust network to include a plurality of nodes that is representative of users in a social network and a plurality of edges that connect the plurality of nodes to represent a trusted relationship between the users represented by the plurality of nodes. In still another embodiment, a step or steps can be implemented for constructing the user trust network based on one or more of an external relationship, an internal relationship, and a propagated relationship. In yet another embodiment, a step can be provided for configuring the user trust network based on the external relationship by: importing a user relationship from an external social media in order to thereafter derive an explicit Boolean trust value based on the relationship defined in the social media contact; and computing an implicit trust value based on a user interaction between the users if an explicit relationship does not exist.

In still another embodiment, user trust network can be configured based on the internal relationship by: establishing and capturing the internal relationship from a service marketplace portal in order to thereafter provide an explicit trust rating by a first user to a second user based on the quality of service provided by the second user; and computing an implicit trust value based on the user interaction in the marketplace portal if the explicit relationship does not exist. In another embodiment, the user trust network can be configured based on the propagated relationship by: determining a propagated relationship based on a buyer aggregated rating on a service provided by a seller; and computing a mean value of the buyer aggregated rating with respect to the service provided by the seller to determine an implicit trust value in order to thereafter calculate an edge weight to denote a trust value of the users and the explicit and implicit propagated trust value.

In yet another embodiment, the service trust network can be configured by: computing the service trust network with a set of vertices, each of which denotes the service and a set of edges between the vertices represents a dependence type transaction between the service; and obtaining a trust value from a service usage log in order to thereafter compute an edge weight to represent the trust value between the services. In still another embodiment, the service trust network can be configured by identifying a plurality of semantic service categories associated with the set of vertices by an agglomerative hierarchical clustering based on a service pair-wise semantic similarity.

In another embodiment, the combined network can be configured by: correlating and combining the user trust network and the service trust network utilizing the user service rating and a service ownership in order to thereafter generate the propagated trust and the inferred service rating; adding a direct trustful relationship between the users who are not directly connected in the social network in order to enrich the user trust network by utilizing the propagated relationship; and determining the inferred service rating based on a trustful value between the users even if the user does not previously rate the service provided by another user but possess a direct connection in the social network.

In another embodiment, the aforementioned random walk model can be configured by: halting the random walk if the user on a step possesses a rating on a target service in order to thereafter return a service rating value; terminating the random walk if the user does not have a rating in order to thereafter select and return the service rating value similar to the target service rated by the user; and terminating the random walk in order to thereafter perform the random walk with respect to another user who is a direct trusted neighbor. In another embodiment, the aforementioned service trust network can be incorporated into a rating calculation in order to provide reliable ratings for the target service with less data noises.

In still other embodiments, steps can be provided for performing the random walk at least once for each target service within a navigation category depending on whether the user is navigating in the service marketplace category and/or search for an interested service; and aggregating the ratings returned by the random walk in order to obtain the predicted rating if the random walk is performed several times.

In yet another embodiment, a system for recommending services can be implemented. Such a system can include, for example, a processor and a data bus coupled to the processor. Such a system can also include a computer-usable medium embodying computer code, the computer-usable medium being coupled to the data bus. Such computer program code can include instructions executable by the processor and configured for, for example, configuring a user trust network and a service trust network in order to thereafter combine the user trust network and the service trust network to form a combined trust network that includes an explicit trust and an implicit trust; conducting a trust-oriented random walk model on a user node with respect to the combined trust network based on a user search intent and navigation behavior in order to select and recommend a service candidate; and predicting a service rating by considering a user rating of a target service, a propagated trust, and an inferred service rating in order to enhance the service rating prediction accuracy and provide an accurate service recommendation.

In another embodiment, the aforementioned instructions can be configured for arranging the user trust network and the service trust network to include a plurality of nodes that is representative of users in a social network and a plurality of edges that connect the plurality of nodes to represent a trusted relationship between the users represented by the plurality of nodes. In another embodiment, such instructions can be configured for constructing the user trust network based on at least one of: an external relationship, an internal relationship, and a propagated relationship. In still other embodiments, such instructions can be modified for configuring the user trust network based on the external relationship by: importing a user relationship from an external social media in order to thereafter derive an explicit Boolean trust value based on the relationship defined in the social media contact; and computing an implicit trust value based on a user interaction between the users if an explicit relationship does not exist.

In yet other embodiments, such instructions can be modified for configuring the user trust network based on the internal relationship by: establishing and capturing the internal relationship from a service marketplace portal in order to thereafter provide an explicit trust rating by a first user to a second user based on a quality of service provided by the second user; and computing an implicit trust value based on the user interaction in the marketplace portal if the explicit relationship does not exist.

In still other embodiment, such instructions can be modified for configuring the user trust network based on the propagated relationship by: determining a propagated relationship based on a buyer aggregated rating on a service provided by a seller; and computing a mean value of the buyer aggregated rating with respect to the service provided by the seller to determine an implicit trust value in order to thereafter calculate an edge weight to denote a trust value of the users and the explicit and implicit propagated trust value.

In still other embodiments, such instructions can be modified for configuring the service trust network by: computing the service trust network with a set of vertices, each of which denotes the service and a set of edges between the vertices represents a dependence type transaction between the service; and obtaining a trust value from a service usage log in order to thereafter compute an edge weight to represent the trust value between the services. In other embodiments, such instructions can be modified for configuring the service trust network by identifying a plurality of semantic service categories associated with the set of vertices by an agglomerative hierarchical clustering based on a service pair-wise semantic similarity.

In yet other embodiments, such instructions can be modified for configuring the aforementioned combined network by correlating and combining the user trust network and the service trust network utilizing the user service rating and a service ownership in order to thereafter generate the propagated trust and the inferred service rating; adding a direct trustful relationship between the users who are not directly connected in the social network in order to enrich the user trust network by utilizing the propagated relationship; and determining the inferred service rating based on a trustful value between the users even if the user does not previously rate the service provided by another user but possess a direct connection in the social network.

In still other embodiments, such instructions can be modified for configuring the aforementioned random walk model by: halting the random walk if the user on a step possesses a rating on a target service in order to thereafter return a service rating value; terminating the random walk if the user does not have a rating in order to thereafter select and return the service rating value similar to the target service rated by the user; and ending the random walk in order to thereafter perform the random walk with respect to another user who is a direct trusted neighbor. In other embodiments, such instructions can be further configured for incorporating the service trust network into a rating calculation in order to provide reliable ratings for the target service with less data noises. In still other embodiments, such instructions can be further configured for performing the random walk at least once for each target service within a navigation category depending on whether the user is navigating in the service marketplace category and/or search for an interested service; and aggregating the ratings returned by the random walk in order to obtain the predicted rating if the random walk is performed several times.

In yet another embodiment, a processor-readable medium storing code representing instructions to cause a process to perform a process to recommend services can be implemented. Such code can include code to, for example, configure a user trust network and a service trust network in order to thereafter combine the user trust network and the service trust network to form a combined trust network that includes an explicit trust and an implicit trust; conduct a trust-oriented random walk model on a user node with respect to the combined trust network based on a user search intent and navigation behavior in order to select and recommend a service candidate; and predict a service rating by considering a user rating of a target service, a propagated trust, and an inferred service rating in order to enhance the service rating prediction accuracy and provide an accurate service recommendation.

In other embodiments, such code can further comprise code to construct the user trust network based on at least one of: an external relationship, an internal relationship, and a propagated relationship. In another embodiment, such code can include code to configure the user trust network based on the external relationship by: importing a user relationship from an external social media in order to thereafter derive an explicit Boolean trust value based on the relationship defined in the social media contact; and computing an implicit trust value based on a user interaction between the users if an explicit relationship does not exist.

In yet other embodiments, such code can include code to configure the user trust network based on the internal relationship by establishing and capturing the internal relationship from a service marketplace portal in order to thereafter provide an explicit trust rating by a first user to a second user based on a quality of service provided by the second user; and computing an implicit trust value based on the user interaction in the marketplace portal if the explicit relationship does not exist. In still another embodiment, such code can include code to configure the user trust network based on the propagated relationship by: determining a propagated relationship based on a buyer aggregated rating on a service provided by a seller and computing a mean value of the buyer aggregated rating with respect to the service provided by the seller to determine an implicit trust value in order to thereafter calculate an edge weight to denote a trust value of the users and the explicit and implicit propagated trust value.

In yet another embodiment, such code can further include code to configure the service trust network by: computing the service trust network with a set of vertices, each of which denotes the service and a set of edges between the vertices represents a dependence type transaction between the service; and obtaining a trust value from a service usage log in order to thereafter compute an edge weight to represent the trust value between the services. In still other embodiments, such code can further include code to configure the service trust network by identifying a plurality of semantic service categories associated with the set of vertices by an agglomerative hierarchical clustering based on a service pair-wise semantic similarity.

In yet other embodiments, such code can include code to configure the aforementioned combined network by: correlating and combining the user trust network and the service trust network utilizing the user service rating and a service ownership in order to thereafter generate the propagated trust and the inferred service rating; adding a direct trustful relationship between the users who are not directly connected in the social network in order to enrich the user trust network by utilizing the propagated relationship; and determining the inferred service rating based on a trustful value between the users even if the user does not previously rate the service provided by another user but possess a direct connection in the social network.

In still other embodiments, such code can further include code to configure the random walk model by: halting the random walk if the user on a step possesses a rating on a target service in order to thereafter return a service rating value; terminating the random walk if the user does not have a rating in order to thereafter select and return the service rating value similar to the target service rated by the user; and terminating the random walk in order to thereafter perform the random walk with respect to another user who is a direct trusted neighbor. In other embodiments, such code can further include code to incorporate the service trust network into a rating calculation in order to provide reliable ratings for the target service with less data noises.

In another embodiment, such code can further include code to perform the random walk at least once for each target service within a navigation category depending on whether the user is navigating in the service marketplace category and/or search for an interested service, and aggregate the ratings returned by the random walk in order to obtain the predicted rating if the random walk is performed several times.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A method for recommending services, said method comprising:
configuring a user trust network and a service trust network in order to thereafter combine said user trust network and said service trust network to form a combined trust network that includes an explicit trust and an implicit trust;
conducting a trust-oriented random walk model on a user node with respect to said combined trust network based on a user search intent and navigation behavior in order to select and recommend a service candidate; and
predicting a service rating by considering a user rating of a target service, a propagated trust, and an inferred service rating in order to enhance said service rating prediction accuracy and provide an accurate service recommendation.

2. The method of claim 1 further comprising configuring said user trust network and said service trust network to include a plurality of nodes that is representative of users in a social network and a plurality of edges that connect said plurality of nodes to represent a trusted relationship between said users represented by said plurality of nodes.

3. The method of claim 1 further comprising constructing said user trust network based on at least one of: an external relationship, an internal relationship, and a propagated relationship.

4. The method of claim 3 further comprising configuring said user trust network based on said external relationship by:
importing a user relationship from an external social media in order to thereafter derive an explicit Boolean trust value based on said relationship defined in said social media contact; and
computing an implicit trust value based on a user interaction between said users if an explicit relationship does not exist.

5. The method of claim 3 further comprising configuring said user trust network based on said internal relationship by:
establishing and capturing said internal relationship from a service marketplace portal in order to thereafter provide an explicit trust rating by a first user to a second user based on a quality of service provided by said second user: and
computing an implicit trust value based on said user interaction in said marketplace portal if said explicit relationship does not exist.

6. The method of claim 1 further comprising configuring said user trust network based on said propagated relationship by:
determining a propagated relationship based on a buyer aggregated rating on a service provided by a seller; and
computing a mean value of said buyer aggregated rating with respect to said service provided by said seller to determine an implicit trust value in order to thereafter calculate an edge weight to denote a trust value of said users and said explicit and implicit propagated trust value.

7. The method of claim 1 further comprising configuring said service trust network by:
computing said service trust network with a set of vertices, each of which denotes said service and a set of edges between said vertices represents a dependence type transaction between said service; and
obtaining a trust value from a service usage log in order to thereafter compute an edge weight to represent said trust value between said services.

8. The method of claim 7 further comprising configuring said service trust network by:
identifying a plurality of semantic service categories associated with said set of vertices by an agglomerative hierarchical clustering based on a service pair-wise semantic similarity.

9. The method of claim 1 further comprises configuring said combined network by:
correlating and combining said user trust network and said service trust network utilizing said user service rating and a service ownership in order to thereafter generate said propagated trust and said inferred service rating;
adding a direct trustful relationship between said users who are not directly connected in said social network in order to enrich said user trust network by utilizing said propagated relationship; and
determining said inferred service rating based on a trustful value between said users even if said user does not previously rate said service provided by another user but possess a direct connection in said social network.

10. The method of claim 1 further comprising configuring said random walk model by:
halting said random walk if said user on a step possesses a rating on a target service in order to thereafter return a service rating value;
terminating said random walk if said user does not have a rating in order to thereafter select and return said service rating value similar to said target service rated by said user; and
terminating said random walk in order to thereafter perform said random walk with respect to another user who is a direct trusted neighbor.

11. The method of claim 10 further comprising incorporating said service trust network into a rating calculation in order to provide reliable ratings for said target service with less data noises.

12. The method of claim 10 further comprising:
performing said random walk at least once for each target service within a navigation category depending on whether said user is navigating in said service marketplace category and/or search for an interested service; and
aggregating said ratings returned by said random walk in order to obtain said predicted rating if said random walk is performed several times.

13. A system for recommending services, said system comprising:
a processor;
a data bus coupled to said processor; and
a computer-usable medium embodying computer code, said computer-usable medium being coupled to said data bus, said computer program code comprising instructions executable by said processor and configured for:
configuring a user trust network and a service trust network in order to thereafter combine said user trust network and said service trust network to form a combined trust network that includes an explicit trust and an implicit trust;
conducting a trust-oriented random walk model on a user node with respect to said combined trust network based on a user search intent and navigation behavior in order to select and recommend a service candidate; and
predicting a service rating by considering a user rating of a target service, a propagated trust and an inferred service rating in order to enhance said service rating prediction accuracy and provide an accurate service recommendation.

14. The system of claim 13 wherein said instructions are further configured for arranging said user trust network and said service trust network to include a plurality of nodes that is representative of users in a social network and a plurality of edges that connect said plurality of nodes to represent a trusted relationship between said users represented by said plurality of nodes.

15. The system of claim 13 wherein said instructions are further configured for constructing said user trust network based on an external relationship, an internal relationship, and a propagated relationship.

16. The system of claim 13 wherein said instructions are further configured for:
determining a propagated relationship based on a buyer aggregated rating on a service provided by a seller;
computing a mean value of said buyer aggregated rating with respect to said service provided by said seller to determine an implicit trust value in order to thereafter calculate an edge weight to denote a trust value of said users and said explicit and implicit propagated trust value.

17. The system of claim 13 wherein said instructions are further configured for;
computing said service trust network with a set of vertices, each of which denotes said service and a set of edges between said vertices represents a dependence type transaction between said service; and
obtaining a trust value from a service usage log in order to thereafter compute an edge weight to represent said trust value between said services.

18. The system of claim 13 wherein said instructions are further configured for arranging said combined network by:
correlating and combining said user trust network and said service trust network utilizing said user service rating and a service ownership in order to thereafter generate said propagated trust and said inferred service rating;
adding a direct trustful relationship between said users who are not directly connected in said social network in order to enrich said user trust network by utilizing said propagated relationship; and
determining said inferred service rating based on a trustful value between said users even if said user does not previously rate said service provided by another user but possess a direct connection in said social network.

19. A processor-readable medium storing code representing instructions to cause a process to perform a process to recommend services, said code comprising code to:
configure a user trust network and a service trust network in order to thereafter combine said user trust network and said service trust network to form a combined trust network that includes an explicit trust and an implicit trust;
conduct a trust-oriented random walk model on a user node with respect to said combined trust network based on a user search intent and navigation behavior in order to select and recommend a service candidate; and
predict a service rating by considering a user rating of a target service, a propagated trust, and an inferred service rating in order to enhance said service rating prediction accuracy and provide an accurate service recommendation.

20. The processor-readable medium of claim 19 wherein said code further comprises code to construct said user trust network based on at least one of: an external relationship, an internal relationship, and a propagated relationship.
